(19) United States
(12) Patent Application Publication
(10) Pub. No.: US 2025/0294037 A1
(43) Pub. Date: Sep. 18, 2025

(54) SECURE COMMUNICATION SESSION PROTOCOLS FOR FRAUD PREVENTION

(71) Applicant: MBTE Sweden AB, Gothenburg (SE)

(72) Inventors: Ran Meriaz, Atlanta, GA (US); Yoram Meriaz, Tel-Aviv (IL); Alexander Tkachman, Holon (IL)

(21) Appl. No.: 19/081,497

(22) Filed: Mar. 17, 2025

Related U.S. Application Data
(60) Provisional application No. 63/565,840, filed on Mar. 15, 2024.

(51) Int. Cl. H04L 9/40

(52) U.S. Cl. CPC H04L 63/1416

(57) ABSTRACT

Embodiments disclose confirmation communication sessions for voice-based communications for fraud prevention and/or identity verification.

### CROSS REFERENCE TO RELATED APPLICATIONS

This application claims priority to U.S. Patent Application No. 63/565,840 filed Mar. 15, 2024, which is incorporated by reference in its entirety.

### BACKGROUND

The number of applications residents on user devices 105 and other computing entities has exploded. Corresponding, the number and types of potential fraud-related issues have exploded and are becoming more and more difficult to identify. Applications resident on a particular user device or computing entity may be used in fraud detection and prevention protocols.

### BRIEF DESCRIPTION OF THE SEVERAL VIEWS OF THE DRAWINGS

Reference will now be made to the accompanying drawings, which are not necessarily drawn to scale, and wherein:

FIG. 1 is a diagram of a framework that can be used to practice embodiments of the present disclosure.

FIG. 2 is an exemplary schematic diagram of a system according to one embodiment of the present disclosure.

FIG. 3 is an exemplary schematic diagram of a user device 105 according to one embodiment of the present disclosure.

FIG. 4 is a flowchart illustrating operations and processes that can be used in accordance with various embodiments of the present disclosure.

FIGS. 5A, 5B, 6A, 6B, 7A, and 7B show exemplary input and output produced by various embodiments of the present disclosure.

FIGS. 8-9 illustrate communications between various entities in accordance with various embodiments.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY FRAMEWORK

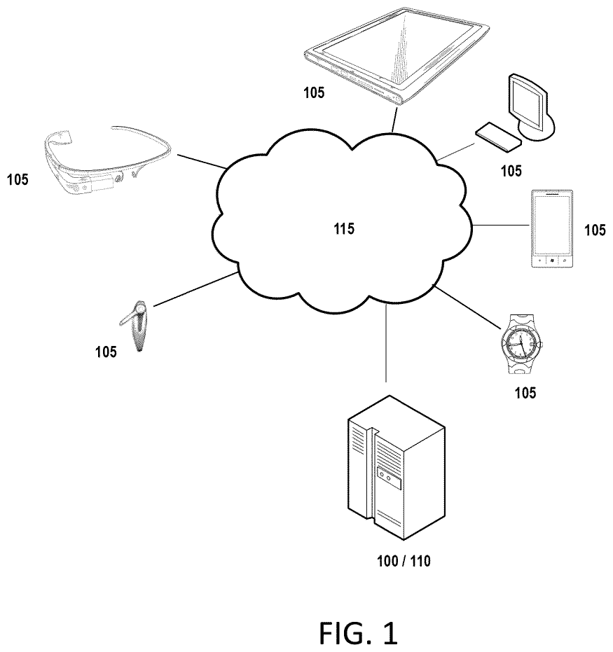

FIG. 1 provides a diagram of a framework that can be used to practice various embodiments of the present disclosure. As shown in FIG. 1, the framework may include one or more merchant systems 100, one or more user devices 105, one or more third-party systems 110, and one or more networks 115. The merchant systems 100, third-party systems 110, and/or other computing entities may be referred to herein as remote computing entities. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular framework.

### 1. Merchant System

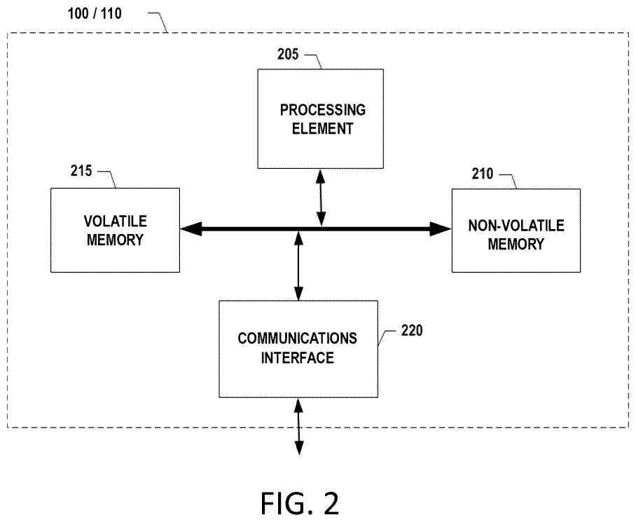

FIG. 2 provides a schematic of a merchant system 100 according to one embodiment of the present disclosure. In general, the terms computing entity, entity, device, system, and/or similar words used herein interchangeably may refer to, for example, one or more computers, computing entities, desktops, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the merchant system 100 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the merchant system 100 may include or be in communication with one or more processing elements 205 (also referred to as processors, processing circuitry, and/or similar terms used herein interchangeably) that communicate with other elements within the merchant system 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the merchant system 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the merchant system 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the merchant system 100 with the assistance of the processing element 205 and operating system.

As indicated, in one embodiment, the merchant system 100 may also include one or more communications interfaces 220 for communicating with or various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the merchant system 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra-wideband (UWB), infrared (IR) protocols, Bluetooth protocols, wireless universal serial bus (USB) protocols, and/or any other wireless protocol. Via such communication protocols, the merchant system 100 can communicate with the user device 105, the third-party system 110, and/or various other computing entities.

Although not shown, the merchant system 100 may include or be in communication with one or more input elements, such as a keyboard input, a mouse input, a touch screen/display input, audio input, pointing device input, joystick input, keypad input, and/or the like. The merchant system 100 may also include or be in communication with one or more output elements (not shown), such as audio output, video output, screen/display output, motion output, movement output, and/or the like.

As will be appreciated, one or more of the merchant system's 100 components may be located remotely from other merchant system 100 components, such as in a distributed system. Furthermore, one or more of the components may be combined and additional components performing functions described herein may be included in the merchant system 100. Thus, the merchant system 100 can be adapted to accommodate a variety of needs and circumstances.

### 2. Exemplary User Device 105

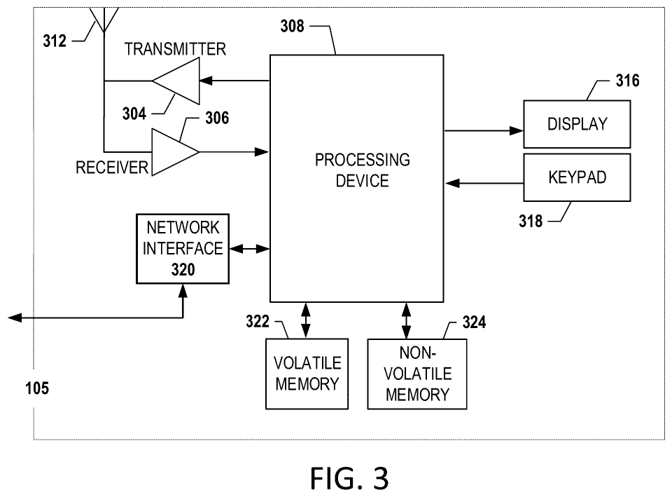

FIG. 3 provides an illustrative schematic representative of a user device 105 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the user device 105 can include an antenna 312, a transmitter 304 (e.g., radio), a receiver 306 (e.g., radio), and a processing element 308 (such as those described above with regard to the merchant system 100) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user device 105 may be capable of operating with one or more air interface standards, communication protocols, modulation types, and access types. More particularly, the user device 105 may operate in accordance with any of a number of wireless communication standards and protocols, such as those described above with regard to the merchant system 100. In a particular embodiment, the user device 105 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, Bluetooth, USB, and/or the like. Via such communication protocols, the user device 105 can communicate with the merchant system 100, the third-party system 110, and/or various other computing entities.

Via these communication standards and protocols, the user device 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user device 105 can also download changes, add-ons, and updates, for instance, to its firmware, software (e.g., including executable instructions, applications, program modules), and operating system. In one embodiment, the user device 105 may be executing an application initiating program that is resident on the user device 105. In one embodiment, the application initiating program may comprise, be associated with, or be in communication with an application initiating database. The application initiating program may also be associated with or be in communication with the merchant system 100 that comprises an application initiating database.

According to one embodiment, the user device 105 may include location determining aspects, devices, modules, functionalities, and/or similar words used herein interchangeably. For example, the user device 105 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user device 105's 105 position in connection with a variety of other systems, including cellular towers, Wi-Fi access points, and/or the like. Similarly, the user device 105 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user device 105 may also comprise a user interface (that can include a display 316 coupled to a processing element 308) and/or a user input interface (coupled to a processing element 308). The user input interface can comprise any of a number of devices allowing the third-party system 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user device 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user device 105 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user device 105.

In another embodiment, the user device 105 may include one or more components that are functionally similar to those of the merchant system 100, as described in greater detail above.

### 3. Exemplary Third-Party System

A third-party may be an individual, a company, an organization, an entity, a department within an organization, a representative of an organization and/or person, and/or the like. In one embodiment, each third-party system 110 may include one or more components that are functionally similar to those of the merchant system 100 and/or the user device 105. For example, each third-party system 110 may include one or more processing elements, one or more display device/input devices (e.g., including user interfaces), volatile and non-volatile storage or memory, and/or one or more communications interfaces. This may enable to the third-party system 110 to communicate with various other computing entities, such as merchant systems 100, user devices 105, and/or various other computing entities. These architectures are provided for exemplary purposes only and are not limiting to the various embodiments. The term computing entity may refer to one or more computers, computing devices, computing entities, distributed systems, servers, blades, gateways, switches, processing devices, processing entities, relays, routers, network access points, base stations, the like, and/or any combination of devices or entities adapted to perform the functions described herein.

It should also be understood that the third-party system 110 may serve as the merchant system 100 in particular embodiments. For example, a third-party may implement various embodiments of the disclosure within its own systems and/or environment. Therefore, in these particular embodiments, third-party system 110 may perform the functionality of the merchant system 100 as detailed herein.

### III. BRIEF OVERVIEW

Voice-based, such as those between a financial-related merchant (e.g., a customer-facing business) and a customer have historically failed to take full advantage of the myriad technical advances that have been introduced to mobile devices (e.g., smartphones with internet connectivity) and therefore voice-based have been limited in functionality. Further, voice-based communications are subject to fraud-related concerns. Various embodiments enable a merchant (e.g., a business, operating a computing entity for receiving voice-based communications) to securely perform protocols for secure communication sessions. For example, upon receipt of a voice-based communication, the receiving computing entity (or a computing entity that controls the voice-based communication) may identify the voice-based communication initiator as purported to be associated with an account for a registered user and may transmit a message to the registered user via an internet-based communication channel (e.g., a text message, merchant app, and/or the like). The message can be used to confirm the identity of the voice-based communication initiator.

### IV. EXEMPLARY SYSTEM OPERATION

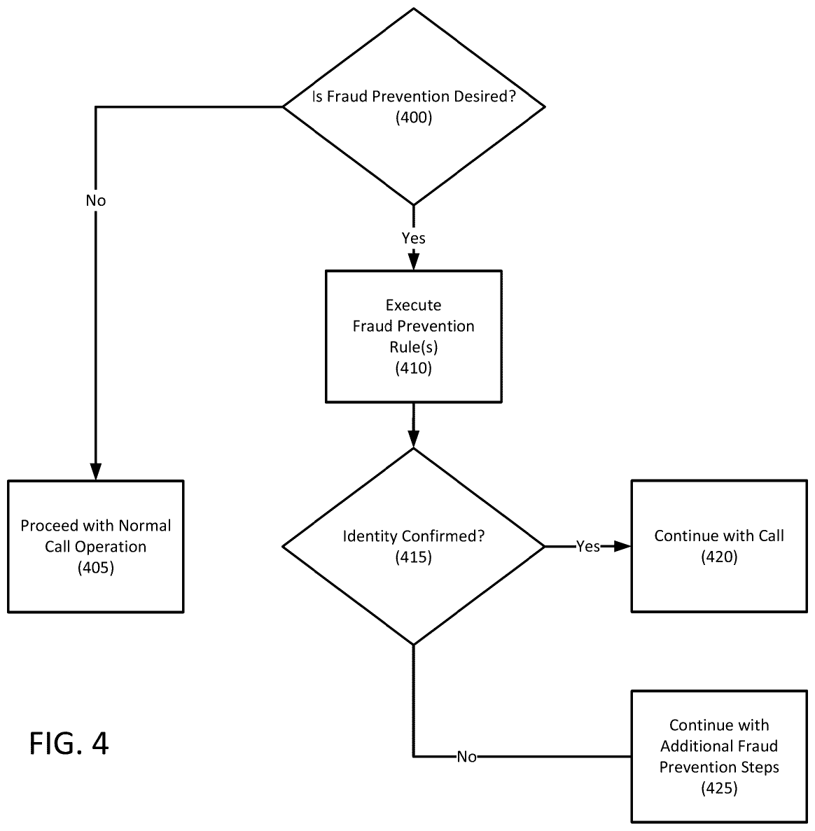

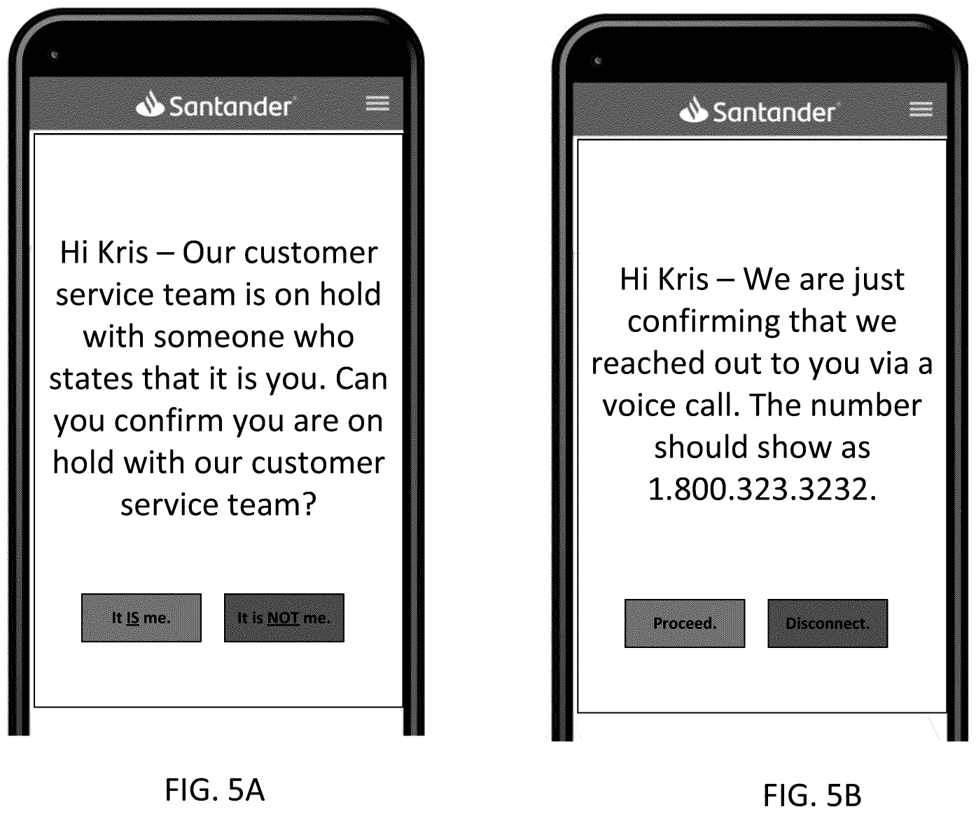

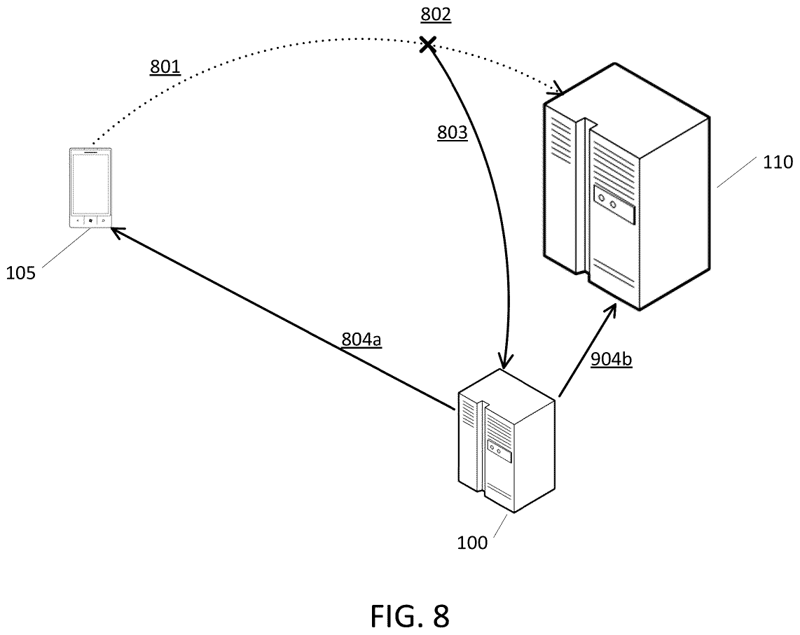

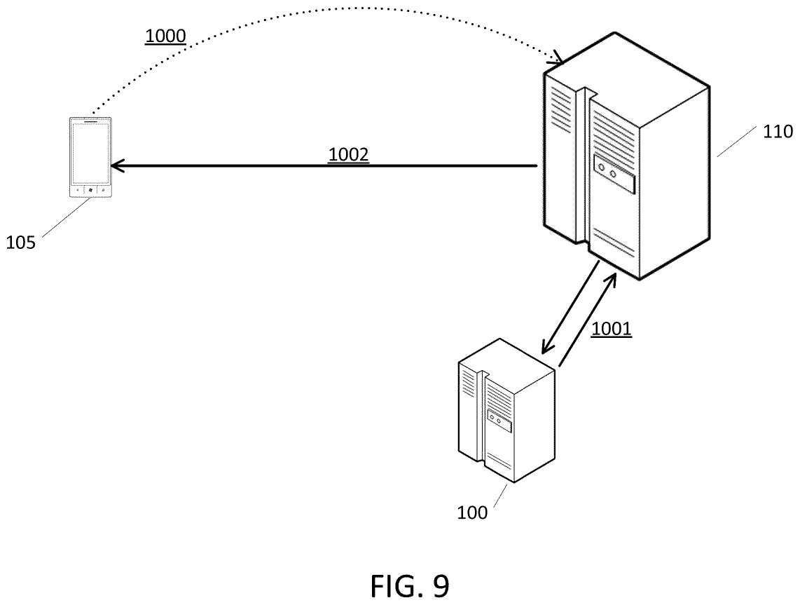

Reference will now be made to FIGS. 4-9. FIG. 4 is a flowchart illustrating operations and processes that may be performed for initiating confirmation communication sessions that may be based at least in part on inbound or outbound phone numbers and/or device identifiers. FIGS. 5A, 5B, 6A, 6B, 7A, and 7B show exemplary input and output produced by various embodiments of the present disclosure. FIGS. 8-9 illustrate communications between various entities in accordance with various embodiments.

In some embodiments, the described approaches may allow for the initiation of confirmation communication sessions to verify identities before sensitive information is exchanged or transactions are conducted. These confirmation communication sessions may take various forms, such as launching, initiating, instructing, and/or controlling dedicated applications, opening specific web pages, or initiating separate messaging or chat conversations. These approaches offer flexibility in defining and applying fraud prevention rules. Such rules may be customized based on factors like time of day, type of communication channel, specific circumstances of the interaction, predicted risk levels, and/or the like.

By providing additional layers of identity verification and security, the described approaches may help reduce instances of fraud and unauthorized access to sensitive information. At the same time, the approaches integrate seamlessly into existing communication flows.

### 1. Registration

In one embodiment, to take advantage of the features described herein, a user, such as an account holder, may need to register for services with a merchant system 100 and/or a third-party system 110. The services provided by the merchant system 100 and/or the third-party system 110 may be provided on a free basis, a fee basis, a subscription basis, a pay-per-use basis, and/or the like. As will be recognized, a variety of other approaches and techniques can be used to adapt to various needs and circumstances.

As part of or after registration, the user may provide one or more communication channels for identify verification and allow the user to receive confirmation of merchant identities and/or third-party identities. As a particular example, as part of a fraud prevention measure, when a user has a voice-based communication with his or her bank, the bank can initiate a fraud prevention protocol to confirm the user's identity before discussing anything with the user. In a similar manner, when receiving a voice-based communication from the bank, the bank representative's identity as being associated with the bank before discussing anything with the bank representative. To do so, either the merchant system 100 and/or the third-party system 110 can be used to confirm the identities of the respective parties.

The merchant or third-party can define multiple fraud prevention rules to provide multiple types of confirmation communication sessions. For example, confirmation communications sessions may involve launching, initiating, instructing, and/or controlling an application resident on a user's user device 105 to enable functionality found in the application and/or launching, initiating, instructing, and/or controlling a feature or functionality of the user's user device 105, such as a text-messaging, device, and/or app-based features or functionality. Those of ordinary skill in the art can envision other types of confirmation communication sessions that may be utilized in light of the present disclosure.

Additionally or alternatively, the fraud prevention rules may define periods (e.g., times of day, days of the week, holidays, and/or the like) in which the confirmation communication sessions should be initiated (or various other circumstances defined by the merchant or third-party). The fraud prevention rules may define security levels for accounts, transaction amounts, and/or other preferences for initiating confirmation communication sessions. The fraud prevention rules may also define phone numbers or device identifiers associated with an account and initiate confirmation communication sessions for any numbers or identifiers not associated with a particular account. The fraud prevention rules may also define whether to establish, terminate/block, track, record, and/or suspend voice-based communications in addition to taking or performing other actions. Such fraud prevention actions may include recording the voice-based communication, tracking the GPS location of the user device 105, flagging a file, generating and/or sending one or more notifications, and/or the like.

The registration process may also involve informing users about these fraud prevention measures and obtaining their consent for such identity confirmation procedures. Users may be given options to customize their preferences for how and when they receive identity confirmation requests.

Functionality provided by the merchant system 100 and/or the third-party system 110, such as confirming identities of users via one or more user devices 105 may be performed directly or indirectly by the merchant system 100, directly or indirectly by the third-party system 110, and/or combinations thereof based at least in part on communications with the merchant system 100 (e.g., via an application program interface (API)-based communication).

In one embodiment, registration may include providing numbers to and/or from user devices 105 that are to be enrolled for secure session communication protocols. In other embodiments, a session initiation protocol (SIP)-based network may be utilized by the merchant system 100 and/or third-party system 110, enabling the merchant system 100 and/or third-party system 110 to control and/or redirect voice-based communications made to specific numbers to the merchant system 100. For functionality provided by the third-party system 110 based at least in part on communications with the merchant system 100, registration may include establishing an API-based communication channel between the third-party system 110 and the merchant system 100 enabling the third-party system 110 to communicate contextual data of received or placed voice-based communications to the merchant system 100, thereby enabling the merchant system 100 and/or third-party system 110 to apply appropriate fraud prevention rules and to provide instructional data back to the third-party system 110 that causes the third-party system 110 to perform appropriate actions.

As part of registration, a user, e.g., via user device 105, may create and/or sign into a merchant app resident on the user device 105, a merchant website, and/or the like. This may include creating a username and access credentials (e.g., password, passkey, biometric information, and/or the like). Similarly, a merchant representative may be required to log in to the merchant system 100 to establish confirmation communication sessions.

### 2. Confirmation Communication Session Initiation

In one embodiment, a confirmation communication session between a user (e.g., via a user device 105) and a merchant representative (e.g., via a merchant system 100 and/or third-party system 110) may be initiated as a result of the user placing or receiving a voice-based communication on a user device 105. For instance, in one embodiment, a user device 105 (e.g., executing a confirmation communication session initiation program) placing an outbound voice-based communication or receiving an inbound voice-based communication can initiate the fraud prevention rules to establish a confirmation communication session (Block 400 of FIG. 4). For example, as a user dials a phone number via the user device 105, an appropriate computing entity (e.g., the user device 105, the merchant system 100, and/or the third-party system 110) can determine/identify whether fraud prevention is desired. Similarly, as a user receives a phone voice-based communication, appropriate computing entity (e.g., the user device 105, the merchant system 100, and/or the third-party system 110) can be used to perform the fraud prevention protocols.

In another embodiment, the fraud prevention rules can be implemented when a user accesses a particular app or website, wants to carry out a transaction, receives a notification or message requesting a response or action by the user, the user is in process with a voice-based communication and would like confirmation as to the identity of the party is on the other end of the voice-based communication, and/or the like simultaneous to a voice-based communication.

If the fraud prevention rules are not to be used with regard to an inbound or outbound voice-based communication (or other in place protocols), then the appropriate computing entity (e.g., the user device 105, the merchant system 100, and/or the third-party system 110) can allow the voice-based communication to proceed with normal voice-based communication operation (Block 405 of FIG. 4). Such normal voice-based communication operation may include connecting (e.g., establishing) the voice-based communication between the parties, for example, or simply allow the call to continue if already connected. As will be recognized, a variety of other approaches and techniques can be used to adapt to various needs and circumstances.

However, if the fraud prevention rules are to be used with regard to an inbound or outbound voice-based communication, in response to a request, and/or in various other circumstances, then the appropriate computing entity (e.g., the user device 105, the merchant system 100, and/or the third-party system 110) can execute one or more fraud prevention rules (Block 410 of FIG. 4). For example, an applicable fraud prevention rule may indicate the voice-based communication should be suspended and an app should be opened to initiate a chat session between the user and either the merchant or the third-party. In another example, the fraud prevention rules may indicate that a message should be transmitted to the user device 105 including a URI directing a browser resident on the user device 105 to open a particular webpage. The URI may be generated specifically for the voice-based communication (communication session), such that, upon the merchant system 100 and/or the third-party system 110 determining that the URI has been accessed, the third-party system 110 and/or the merchant system 100 may suspend the voice-based communication while an identity is being confirmed. Accordingly, other types of confirmation communication sessions may be utilized.

Depending on the embodiment, an appropriate computing entity (e.g., the third-party system 110, the merchant system 100, and/or the user device 105) may identify the applicable fraud prevention rule(s) and determine the action(s) to take. Accordingly, an appropriate computing entity (e.g., the third-party system 110, the merchant system 100, and/or the user device 105) may perform the appropriate actions based at least in part on the applicable fraud prevention rules (Block 410 of FIG. 4). In one embodiment, as part of that, the user is presented with an interface for the confirmation communication session via the user device 105.

Via the confirmation communication session, the user may decide to use the confirmation communication session or take other action. Accordingly, the appropriate computing entity (e.g., the merchant system 100, the user device 105, and/or the third-party system 110) may determine whether the user has decided to continue with the confirmation communication session (Block 415 in FIG. 4). This may require that the user be logged in to a merchant app or website, third-party merchant app or website, and/or the like via user credentials, biometrics, and/or the like.

If the user has either confirmed his or her identity or received confirmation of the merchant representative's identity, an appropriate computing entity (e.g., the third-party system 110, the merchant system 100, and/or the user device 105) may allow the voice-based communication to proceed with the normal voice-based communication operation (Block 420 in FIG. 4). If the user has not either confirmed his or her identity or received confirmation of the merchant's identity, an appropriate computing entity (e.g., the third-party system 110, the merchant system 100, and/or the user device 105) may perform one or more additional fraud prevention steps (Block 425 in FIG. 4). Accordingly, an appropriate computing entity (e.g., the third-party system 110, the merchant system 100, and/or the user device 105) may disconnect/terminate the voice-based communication using various mechanisms. For example, the user device 105 may simply terminate the voice-based communication (hang up), send a signal to the carrier or network, the merchant system 100, and/or the third-party system 110 to terminate the voice-based communication and/or the like.

As will be recognized, in some embodiments, the voice-based communication may be controlled, instructed, and/or initiated remotely from the merchant system 100 and or the third-party system 100 or locally by the user device 105. For example, the third-party system 110 or the merchant system 100 may simply disconnect/terminate or continue the voice-based communication without any involvement of the user device 105. Therefore, in these particular embodiments, the appropriate computing entity (e.g., the user device 105, the merchant system 100, and/or the third-party system 110) may simply direct the user to the confirmation communication session. In another example, the carrier or network being used for the voice-based communication may send a signal or simply discontinue/terminate or continue the voice-based communication. Accordingly, the merchant system 100, third-party system 110, and/or carrier system can use various mechanisms in determining whether the user has decided to use the confirmation communication session, as well as various mechanisms with respect to disconnecting/terminating or continuing the voice-based communication.

Another method for initiating a confirmation communication session may utilize the text messaging capabilities of the user's device 105. The system may send a message to the user's device 105, prompting the users to engage in a text-based confirmation process. This approach may leverage existing messaging functionality on the device without requiring additional software installation.

To enhance security and tracking, the system may generate a unique URI for each individual voice-based communication or communication session. This unique identifier may allow the merchant or third-party system to monitor whether the URI has been accessed, providing insight into the user's engagement with the confirmation process. The system may use this information to determine subsequent actions, such as proceeding with or suspending the original voice-based communication.

In one embodiment, when a confirmation communication session is initiated, the original voice-based communication may be suspended, muted, paused, placed in a queue, and/or the like pending the completion of the identity verification process. The user may be presented with options to proceed with the confirmation communication session, continue with the original voice-based communication, or take other actions such as ending the interaction.

By providing multiple methods for initiating confirmation communication sessions, the system may offer flexibility in addressing different security scenarios and user preferences. This approach may help balance the need for robust fraud prevention with user convenience across various types of interactions and communication channels.

### 3. Confirmation Communication Sessions

In particular embodiments, appropriate computing entity (e.g., the user device 105, the merchant system 100, and/or the third-party system 110) can initiate confirmation communication sessions. For example, before, simultaneous to, during, and/or after calling a phone number and/or device identifier associated with a user device 105, an appropriate computing entity (e.g., the user device 105, the merchant system 100, and/or the third-party system 110) can provide instructions to the user's user device 105 to initiate a confirmation communication session. For example, assume a user voice-based communications Santander using his user device 105. The voice-based communication can be controlled by an appropriate computing entity (by Santander, as the third-party system 110 or by the merchant system 100), and the appropriate computing entity may provide instructions to the user device 105 for performing the initiation of a confirmation communication session. For example, the appropriate computing entity may send a message using the phone number and/or device identifier associated with the user account for performing the initiation of a confirmation communication session, such as via a hyperlink, URI, App voice-based communication, instruction to use a particular app to perform the confirmation communication session, and/or the like. As will be recognized, the third-party system 110 and/or merchant system 100 (e.g., in communication with the user device 105) can provide instructions to such user devices 105 to perform a variety of actions before, simultaneous to, during, and/or after a voice-based communication. As will be recognized, a variety of other approaches and techniques can be used to adapt to various needs and circumstances.

a. Control by a Merchant System 100

FIG. 8 schematically illustrates the operation of a methodology by a merchant system 100 applying appropriate fraud prevention rules for establishing appropriate confirmation communication sessions between the user device 105 and the third-party, in accordance with the applicable fraud prevention rules.

In one embodiment, a user device 105 receives or initiates a voice-based communication to the third-party (specifically, to be received by the third-party system 110), as indicated by dashed line 801. However, rather than directly connecting the user device 105 with the third-party system 110, the voice-based communication is controlled, as indicated by the “X” designated as 802 and routed to the merchant system 100 for fraud prevention. The merchant system 100 thus receives data indicative of a phone number and/or device identifier or account information. In accordance with the embodiment of FIG. 8, the third-party may have an agreement in place with the merchant system operator, such that voice-based communications to and/or from user devices 105 are to be controlled and the merchant system 100 is able to apply fraud prevention rules established by the third-party and applied by the merchant system 100.

Controlling the voice-based communication may encompass retrieving relevant fraud prevention rules to be applied to voice-based communications initiated by or received from a particular phone number and/or device identifier. In other embodiments, controlling the voice-based communication may encompass controlling the voice-based communication at a switchboard managed by the merchant system 100, as the voice-based communication would typically continue to the third-party system 110. In other embodiments, controlling a voice-based communication may rely on internet-based calling protocols, such as Voice-over-IP (VoIP) or SIP calling. Under internet-based calling protocols, once a voice-based communication is received at an SIP trunk of the third-party system 110, the voice-based communication may be directed to an appropriate recipient (thereby controlling the voice-based communication), such as to direct the voice-based communication to the merchant system 100.

As indicated at line 803, the controlled voice-based communication is routed to the merchant system 100. The merchant system 100 then retrieves appropriate fraud prevention rules to be applied. As mentioned above, the fraud prevention rules may be time dependent (e.g., voice-based communications received or placed during a particular time period are routed directly to the third-party system 110 to complete the voice-based communication, while voice-based communications received or placed outside of the particular time window may still provide the option to continue using a confirmation communication session). The fraud prevention rules may also be device dependent. For example, voice-based communications to or from a phone number associated with a landline may be connected directly to the third-party system 110, while voice-based communications from an initiator phone number associated with a user device 105 may be managed by the transmission of a message to the initiator phone number and/or device identifier associated with the user device 105 providing the option to continue using a confirmation communication session. Other fraud prevention rules may be implemented in various embodiments.

As indicated at lines 804a and 804b, the merchant system 100 applies the fraud prevention rules to provide appropriate communications to the user device 105 and/or the third-party system 110. As shown, if the fraud prevention rules dictate that the merchant system 100 is to transmit a message, instruction, notification, and/or the like to the user device 105 (as reflected at line 804a) initiating a confirmation communication session, the merchant system 100 provides the same to the user device 105. The content of the message may be retrieved from a memory storage area associated with the merchant system 100. The content of the message may be provided by the merchant system 100 and/or the third-party system 110, and may be automatically generated, manually generated, or partially automatically generated. In certain embodiments, the content of the message may be specific to the user device 105 (as determined based at least in part on the initiator phone number) if the phone number is known to the third-party system 110 (as reflected within a memory storage area accessible to the merchant system 100). In such embodiments, the voice-based-communication-initiator-specific content may be retrieved from the memory accessible to the merchant system 100 by identifying content associated with the initiator phone number. In other embodiments, the content of the message may be caller-agnostic, such that all callers (or all unknown callers) receive a message having identical content. In some embodiments, the content of the message may be unique to a particular phone voice-based communication (e.g., a URI included within the message may be specific to a particular phone voice-based communication, thereby enabling the third-party system 110 to determine if the voice-based communication initiator selects an element associated with the URI (by determining whether any web-traffic is directed to the particular URI).

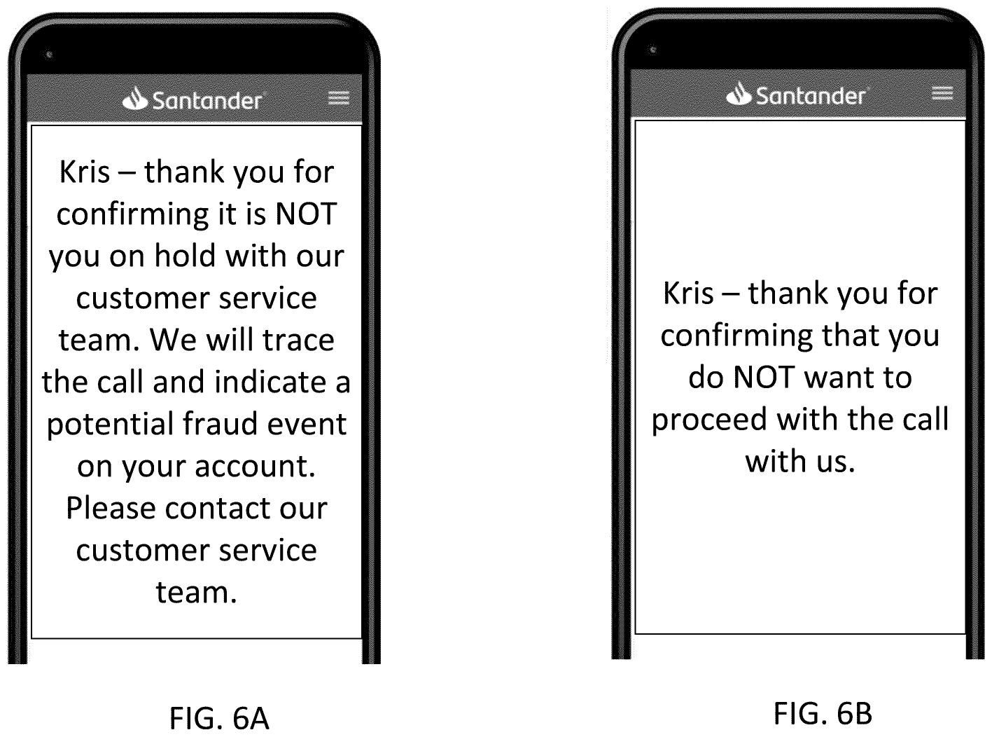

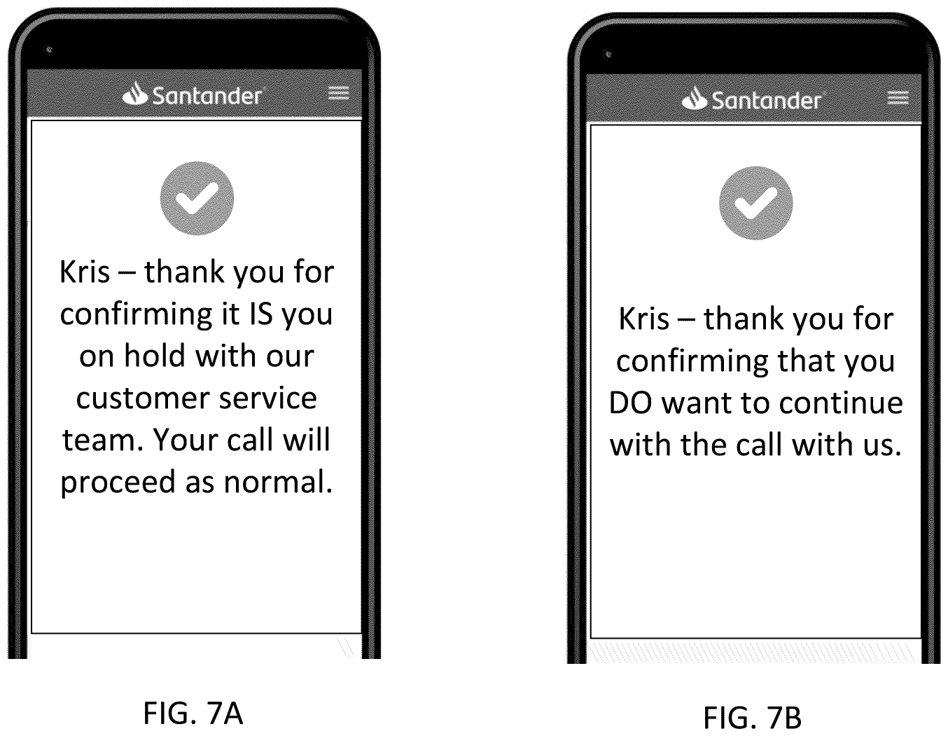

FIGS. 5A, 5B, 6A, 6B, 7A, and 7B provide example displays that may be used in accordance with various embodiments of the disclosure. FIGS. 5A and 5B are displays that may be provided through a browser, message, or app to the user on his or her user device 105 that provide confirmation communication session requesting that the user confirm his or her identity or confirming the merchant's identity. Accordingly, this display may be provided to the user as a result of the user placing a voice-based communication to or receiving a voice-based communication from a merchant (e.g., Santander). FIG. 5A is an example where the user device 105 initiates the voice-based communication. FIG. 5B is an example where the user device 105 is receiving a voice-based communication. In both cases, the voice-based communication may be suspended, and the display may be provided to the user with the options via the confirmation communication session (e.g., chat session), hang up, continue with the voice-based communication, initiate fraud prevention steps. FIG. 6A follows from 5A, and FIG. 6B follows from FIG. 5B. In FIGS. 6A and 6B, the user has selected an element to not proceed with the voice-based communication—whether being placed or received. Similarly, FIG. 7A follows from 5A, and FIG. 7B follows from FIG. 5B. In FIGS. 7A and 7B, the user has selected an element to proceed with the voice-based communication.

As reflected by line 804b, if the fraud prevention rules dictate that the user device 105 is to be directly connected to the third-party system 110 to connect the original voice-based communication, the merchant system 100 relays the voice-based communication to the third-party system 110 to connect the user device 105 with the third-party system 110. The voice-based communication may then continue as if the voice-based communication initiator was directly connected with the third-party system 110.

In some embodiments, the system may utilize SIP-based networks to control and redirect voice-based communications as part of the fraud prevention process. SIP-based networks may allow for greater flexibility in managing communication sessions and applying fraud prevention measures.
The merchant system and third-party system may play different roles in implementing fraud prevention measures, depending on the specific configuration of the system. In some implementations, the merchant system may directly control voice-based communications and apply fraud prevention rules. Alternatively, the third-party system may manage these functions based on instructions from the merchant system.
When using SIP-based networks, the system may have enhanced capabilities for controlling and redirecting calls. For example, when a voice-based communication is received at an SIP trunk of the third-party system, the voice-based communication may be directed to an appropriate recipient based on predefined rules. This may allow the system to route voice-based communications to the merchant system for fraud prevention processing before connecting to the intended recipient.
The merchant system may store and apply fraud prevention rules directly In some embodiments. These rules may be based on various factors such as time of day, caller information, or specific circumstances of the voice-based communication. The merchant system may use these rules to determine appropriate actions, such as initiating confirmation communication sessions or allowing voice-based communications to proceed normally.
In other implementations, the third-party system may control voice-based communications and communicate with the merchant system to apply fraud prevention rules. The third-party system may provide data about ongoing voice-based communications to the merchant system, which then determines the appropriate actions based on its stored fraud prevention rules. The merchant system may then instruct the third-party system on how to handle the voice-based communication, such as by sending a confirmation message to the user or connecting the voice-based communication directly.
The system may use API-based communication channels between the merchant system and third-party system to facilitate real-time decision-making and action implementation. This may allow for rapid exchange of information and instructions between the two systems, enabling efficient application of fraud prevention measures during live communication sessions.
In some embodiments, the merchant system or third-party system may generate unique identifiers for specific voice-based communications or communication sessions. These identifiers may be used to track user engagement with confirmation processes and determine subsequent actions in the fraud prevention workflow.
By leveraging SIP-based networks and flexible architectures, the merchant system and third-party system may work together to implement robust fraud prevention measures while maintaining efficient voice-based communication management and routing capabilities.
b. Control by the Third-Party System 110

FIG. 9 schematically illustrates a methodology by which the third-party system 110 applies fraud prevention rules for voice-based communications to or from user devices 105. As just one example, the third-party system 110 is configured to communicate with the merchant system 100 via one or more Application Program Interfaces (APIs) that operate to translate data generated by the third-party system 110 into a data format consumable by the merchant system 100. Data generated and transmitted from the merchant system 100 to the third-party system 110 may similarly pass through an API such that the data generated by the merchant system 100 is consumable by the third-party system 110. Under such a configuration, the merchant system 100 stores and directly applies the fraud prevention rules based at least in part on data about ongoing voice-based communications that are received from the third-party system 110. Communications between the third-party system 110 and the merchant system 100 occur in real-time, upon receipt of an incoming voice-based communication or outbound voice-based communication by the third-party system 110, such that the merchant system 100 provides data to the third-party system 110 to enable the third-party system 110 to appropriately manage incoming voice-based communications or outbound voice-based communications in accordance with applicable fraud prevention rules (e.g., by transmitting messages back to the voice-based communication initiator providing operations for a confirmation communication session, by connecting the voice-based communication according to typical voice-based communication operations, and/or the like).

As shown in FIG. 9, the user device 105 can initiate or receive a voice-based communication as indicated by line 900. The user device 105 is directly connected with the third-party system 110.

The third-party system 110 can provide data to the merchant system 100 (e.g., via an API-based communication channel) indicative of the received or placed voice-based communication, as indicated at 9001. The provided data additionally comprises data indicative of the phone number and/or device identifier of the third-party system 110 (as different phone numbers and/or device identifiers have different applicable fraud prevention rules).

The merchant system 100 then retrieves appropriate fraud prevention rules to be applied. As mentioned above, the fraud prevention rules may be time dependent (e.g., voice-based communications received or placed during a particular time period are routed directly to the third-party system 110 to complete the voice-based communication, while voice-based communications received or placed outside of the particular time window may still provide the option to continue using a confirmation communication session). The fraud prevention rules may also be device dependent. For example, voice-based communications to or from an initiator phone number associated with a landline may be connected directly to the third-party system 110, while voice-based communications from an initiator phone number associated with a user device 105 may be managed by the transmission of a message to the initiator phone number and/or device identifier associated with the user device 105 providing the option to continue using a confirmation communication session. Other fraud prevention rules may be implemented in various embodiments.

The merchant system 100 applies the fraud prevention rules to determine how the third-party system 110 should handle the voice-based communication and provide data back to the third-party system 110 (e.g., via an API based communication channel), as reflected at 9001. For example, if the fraud prevention rules dictate that the third-party system 110 is to transmit a message, instruction, notification, and/or the like to the user device 105 (as reflected at line 1002) initiating a confirmation communication session, the merchant system 100 provides data to the third-party system 110 instructing the third-party system 110 to provide the same to the user device 105. The data provided to the third-party system 110 may contain the message to be transmitted, or the data provided to the third-party system 110 may instruct the third-party system 110 to retrieve an appropriate message from a memory accessible to the third-party system 110 to transmit to the user device 105. In certain embodiments, the content of the message may be specific to the user device 105 (as determined based at least in part on the initiator phone number) if the initiator phone number is known to the third-party system 110 (as reflected within a memory storage area accessible to the merchant system 100). In such embodiments, the voice-based-communication-initiator-specific content may be retrieved from the memory accessible to the merchant system by identifying content associated with the initiator phone number. In other embodiments, the content of the message may be caller-agnostic, such that all callers (or all unknown callers) receive a message having identical content. In some embodiments, the content of the message may be unique to a particular phone voice-based communication (e.g., a URI included within the message may be specific to a particular phone voice-based communication, thereby enabling the third-party system 110 to determine if the voice-based communication initiator selects an element associated with the URI (by determining whether any web-traffic is directed to the particular URI).

FIGS. 5A, 5B, 6A, 6B, 7A, and 7B provide example displays that may be used in accordance with various embodiments of the disclosure. FIGS. 5A and 5B are displays that may be provided through a browser, message, or app to the user on his or her user device 105 that provide confirmation communication session requesting that the user confirm his or her identity or confirming the merchant's identity. Accordingly, this display may be provided to the user as a result of the user placing a voice-based communication to or receiving a voice-based communication from a merchant (e.g., Santander). FIG. 5A is an example where the user device 105 initiates the voice-based communication. FIG. 5B is an example where the user device 105 is receiving a voice-based communication. In both cases, the voice-based communication may be suspended, and the display may be provided to the user with the options via the confirmation communication session (e.g., chat session), hang up, continue with the voice-based communication, initiate fraud prevention steps. FIG. 6A follows from 5A, and FIG. 6B follows from FIG. 5B. In FIGS. 6A and 6B, the user has selected an element to not proceed with the voice-based communication—whether being placed or received. Similarly, FIG. 7A follows from 5A, and FIG. 7B follows from FIG. 5B. In FIGS. 7A and 7B, the user has selected an element to proceed with the voice-based communication.

Additionally or alternatively, as another measure of security, the user device 105 can grant the app, for example, executing the voice-based communication with various system level permissions. In one embodiment, the granting the app such permissions may allow the app to determine if a voice-based communication is being conducted in real-time and the source number and/or identifiers associated with the voice-based communication. This allows a further confirmation in addition to the user interface element being selected and/or shown as part of the confirmation communication session.

If the fraud prevention rules dictate that the user device 105 is to be directly connected to the third-party system 110 to connect the original voice-based communication, the merchant system 100 transmits instructions to the third-party system 110 to connect the user device 105 with the third-party system 110 to complete the voice-based communication.

As will be recognized, the fraud prevention and identity confirmation system may integrate multiple components to enhance security during communication sessions. This integration may involve user devices 105, merchant systems 100, and third-party systems 110 working together to implement robust security measures.

The system may begin its operation when a user initiates or receives a voice-based communication. Upon detection of this communication event, the system may evaluate whether fraud prevention measures should be applied based on predefined rules. These rules may consider factors such as the time of the voice-based communication, the type of device used, or the specific phone number involved. Communication between these systems may occur through API-based and/or other channels, allowing for real-time exchange of information and instructions. This rapid communication may enable efficient application of fraud prevention measures during live communication sessions. As part of the confirmation process, the system may generate unique identifiers for specific voice-based communications or communication sessions. These identifiers may be used to track user engagement with the confirmation process and determine subsequent actions in the fraud prevention workflow.

The user device 105 may play an important role in the integrated system by serving as the interface for identity confirmation. The device may receive instructions to display confirmation prompts, launch specific applications, or open secure webpages. The user's responses and interactions with these prompts may be transmitted back to the merchant or third-party system for verification.

The integrated system may also incorporate various data sources to enhance its decision-making capabilities. This may include accessing user account information, transaction history, or device-specific data to inform the application of fraud prevention rules. By combining these various components and processes, the integrated system may provide a comprehensive approach to fraud prevention and identity confirmation. The seamless interaction between user devices 105, merchant systems 100, and third-party systems 110.

### V. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for confirmation communication sessions, comprising:
during a voice-based communication between a user device and a system, receiving an instruction to launch the confirmation communication session on the user device;
responsive to receiving the instruction to launch the confirmation communication session on the user device, launching an application on the user device, wherein the application displays an interactive interface for a user of the user device to interact with;
in an instance in which the user selects a user interface element confirming the confirmation communication session, allowing the voice-based call to continue; and
in an instance in which the user selects a user interface element not confirming the confirmation communication session, terminating the voice-based call.

2. The method of claim 1, wherein the instruction originates from the system.

3. The method of claim 1, wherein initiating the confirmation communication session comprises launching, initiating, instructing, and/or controlling a dedicated application on the user device 105.

4. The method of claim 1 further comprising suspending or muting the voice-based communication during the confirmation communication session.

5. The method of claim 1, wherein one or more predefined rules specify time periods during which confirmation communication sessions can be initiated.

6. The method of claim 1 further comprising determining whether the source of the voice-based call.

7. A system comprising:
one or more processors; and
one or more memories storing processor-executable instructions that, when executed by the one or more processors, cause the one or more processors to perform operations comprising:
during a voice-based communication between a user device and a system, receiving an instruction to launch the confirmation communication session on the user device;
responsive to receiving the instruction to launch the confirmation communication session on the user device, launching an application on the user device, wherein the application displays an interactive interface for a user of the user device to interact with;
in an instance in which the user selects a user interface element confirming the confirmation communication session, allowing the voice-based call to continue; and
in an instance in which the user selects a user interface element not confirming the confirmation communication session, terminating the voice-based call.

8. The system of claim 7, wherein the instruction originates from the system.

9. The system of claim 7, wherein initiating the confirmation communication session comprises launching, initiating, instructing, and/or controlling a dedicated application on the user device 105.

10. The system of claim 7, wherein the operations further comprise suspending or muting the voice-based communication during the confirmation communication session.

11. The system of claim 7, wherein one or more predefined rules specify time periods during which confirmation communication sessions can be initiated.

12. The system of claim 7, wherein the operations further comprise determining whether the source of the voice-based call.

13. One or more non-transitory computer-readable storage media including instructions that, when executed by one or more processors, cause the one or more processors to:
during a voice-based communication between a user device and a system, receiving an instruction to launch the confirmation communication session on the user device;
responsive to receiving the instruction to launch the confirmation communication session on the user device, launching an application on the user device, wherein the application displays an interactive interface for a user of the user device to interact with;
in an instance in which the user selects a user interface element confirming the confirmation communication session, allowing the voice-based call to continue; and
in an instance in which the user selects a user interface element not confirming the confirmation communication session, terminating the voice-based call.

14. The one or more non-transitory computer-readable storage media of claim 13, wherein the instruction originates from the system.

15. The one or more non-transitory computer-readable storage media of claim 13, wherein initiating the confirmation communication session comprises launching, initiating, instructing, and/or controlling a dedicated application on the user device 105.

16. The one or more non-transitory computer-readable storage media of claim 13, wherein the operations further comprise suspending or muting the voice-based communication during the confirmation communication session.

17. The one or more non-transitory computer-readable storage media of claim 13, wherein one or more predefined rules specify time periods during which confirmation communication sessions can be initiated.

18. The one or more non-transitory computer-readable storage media of claim 13, wherein the instructions further cause the one or more processors to perform operations comprising determining whether the source of the voice-based call.
